(19) United States
(12) Patent Application Publication
(10) Pub. No.: US 2017/0314327 A1
(43) Pub. Date: Nov. 2, 2017

(54) WHEELED CART FOR TRANSPORTING STORE ITEMS

(71) Applicant: Wal-Mart Stores, Inc., Bentonville, AR (US)

(72) Inventors: Jeffrey Green, Bentonville, AR (US); Mark Propes, Bentonville, AR (US)

(21) Appl. No.: 15/498,606

(22) Filed: Apr. 27, 2017

Related U.S. Application Data
(60) Provisional application No. 62/329,357, filed on Apr. 29, 2016.

(30) Foreign Application Priority Data
Apr. 29, 2016 (CA) 2928478

(51) Int. Cl. E06C 5/04; B62B 3/00; B62B 5/04; B62B 5/06

(52) U.S. Cl. CPC E06C 5/04; B62B 5/06; B62B 3/005; B62B 5/0457; B62B 2206/006

(57) ABSTRACT

A cart for transporting items comprises a base portion, comprising: a frame; at least one shelf coupled to the frame; and a set of wheels at the bottom of the frame permitting a movement of the cart; and a collapsible ladder directly attached to the frame.

### RELATED APPLICATIONS

This application claims the benefit of U.S. Provisional Patent No. 62/329,357, filed Apr. 29, 2016, entitled “Wheeled Cart for Transporting Store Items,” and Canadian Patent Application No. 2,928,478, filed Apr. 29, 2016, entitled “Wheeled Cart for Transporting Store Items,” the contents of which are incorporated by reference herein in their entireties.

### FIELD

The present inventive concepts relate generally to wheeled carts used in stores and the like for carrying items for stocking on store shelves, and in particular, to a ladder cart that provides improved efficiency and operator safety during operation.

### BACKGROUND

Conventional wheeled carts may include shelves, each constructed and arranged for transporting store items, for example, used for stocking store or warehouse shelves. Manual labor is required to remove an item from any of the cart shelves. Depending on the height of the cart, a top shelf may be difficult to reach by a person or machine designated to remove an item from the top shelf.

### BRIEF SUMMARY

In one aspect, provided is a cart for transporting items comprising a base portion, comprising: a frame; at least one shelf coupled to the frame; and a set of wheels at the bottom of the frame permitting a movement of the cart; and a collapsible ladder directly attached to the frame.

In another aspect, provided is a cart for retrieving items from a top shelf of a store or warehouse, comprising a base portion, comprising: a frame; a plurality of shelves coupled to the frame, the shelves including a top shelf having a lip about a perimeter of the top shelf; and a set of wheels at the bottom of the frame permitting a movement of the cart. The cart further comprising a collapsible ladder directly attached to the frame, the ladder comprising a plurality of steps including a top step platform that supports the weight of a user and allows the user to transport items to and from the top shelf of the store or warehouse or the top shelf of the base portion of the cart.

In another aspect, provided is a cart for transporting items, comprising: a base portion, comprising: a frame; and a plurality of shelves coupled to the frame; a collapsible ladder directly attached to the base portion; a top latch that transitions between a closed position and an open position to engage or disengage a top step platform of the ladder when raising or lowering the ladder with respect to the base portion; and a bottom latch that disengages the ladder from the frame to allow the ladder to move in a direction of the top latch when a force is applied to the bottom latch.

### BRIEF DESCRIPTION OF THE SEVERAL VIEWS OF THE DRAWINGS

The above and further advantages may be better understood by referring to the following description in conjunction with the accompanying drawings, in which like numerals indicate like structural elements and features in various figures. The drawings are not necessarily to scale, emphasis instead being placed upon illustrating the principles of the concepts.

FIG. 1 is a perspective view of a wheeled cart, in accordance with some embodiments.

FIG. 2 is a perspective view of a wheeled cart, in accordance with other embodiments.

FIG. 3 is a close-up view of a safety element coupled to a ladder of a wheeled cart, in accordance with some embodiments.

FIG. 4 is a view of an operation of the safety element of FIG. 3.

FIG. 5 is another view of the wheeled cart including the safety element of FIGS. 1-4.

FIGS. 6, 7, 8, and 9 are views of a latch release mechanism of a wheeled cart, in accordance with some embodiments.

FIG. 10 is a view of a caster lock mechanism of a wheeled cart, in accordance with some embodiments.

FIGS. 11 and 12 are other views of a cart in an open state, in accordance with some embodiments.

FIG. 13 is a view of a top shelf of a cart, in accordance with some embodiments.

### DETAILED DESCRIPTION

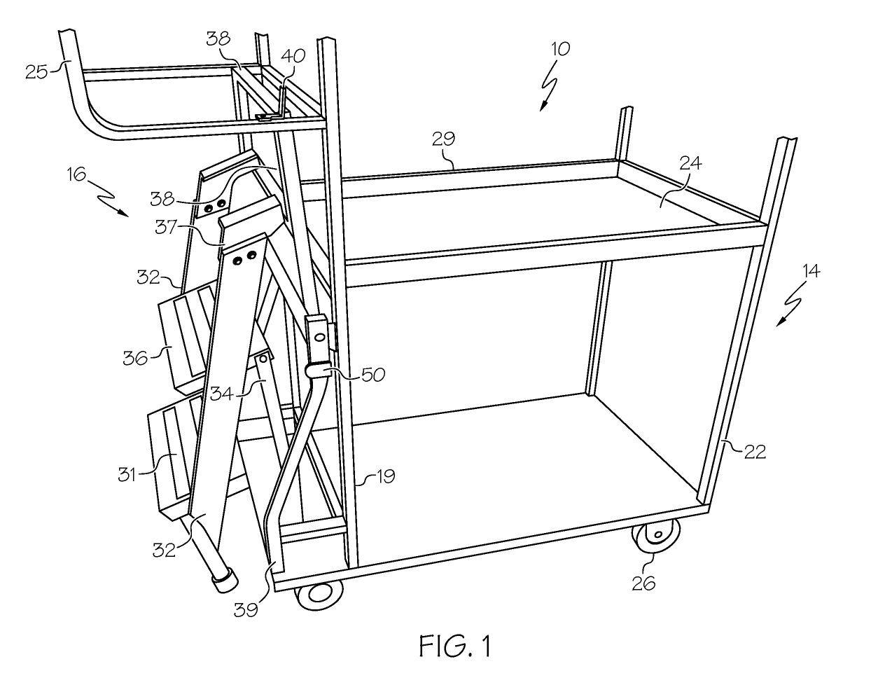

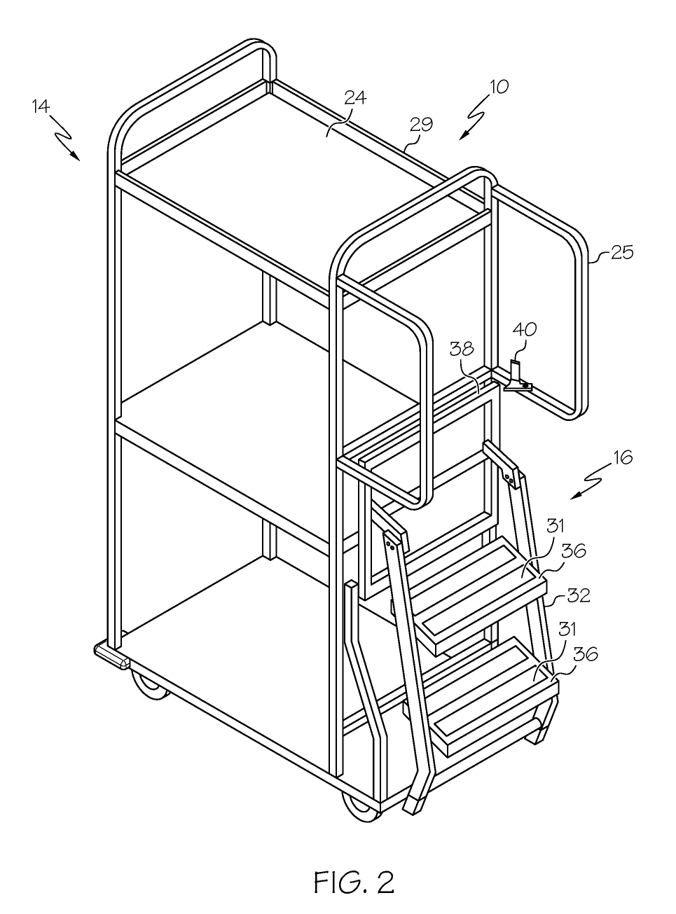

FIG. 1 is a perspective view of a wheeled cart 10, in accordance with some embodiments. FIG. 2 is a perspective view of a wheeled cart 10, in accordance with other embodiments. The carts shown in FIGS. 1 and 2, respectively, may differ only in the presence or absence of various physical features, for example, described herein.

The wheeled cart 10 is constructed for various retail store operations. In some embodiments, the wheeled cart 10 is for transporting store items, for example, used for stocking store or warehouse shelves. In some embodiments, the wheeled cart 10 is constructed and arranged for engaging, or otherwise exchanging packages or other goods with an automated product sorting and/or unload machines.

The cart 10 includes a ladder 16 coupled to a wheeled base portion 14. The base portion 14 includes one or more shelves 24 coupled to a frame 22, or legs 19 of the frame 22. A set of wheels 26 are coupled to a bottom region of the frame 22 or lowest shelf so that the cart 10 can be readily moved to different locations, for example, for stocking items on the cart 10 at a store. The wheeled base portion 14 may include a handle 25 or the like so that a user can push the cart 10 in a forward direction or otherwise move the cart 10.

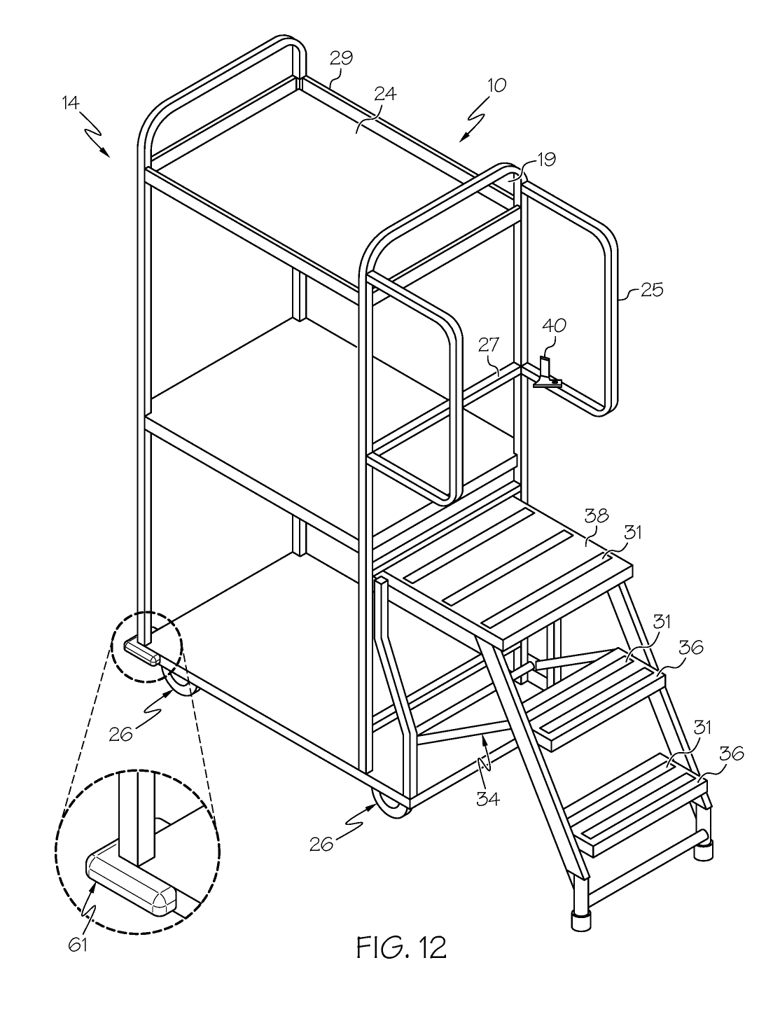

The ladder 16 may be coupled to a frame 19 of the base portion 14, which may include one or more frame legs and/or handle 25, for example. The ladder 16 is configured to open and close relative to the base portion 14, described herein. The ladder 16 is preferably directly coupled to an end of the base portion 14, whereby a user may stand on any of the ladder steps for being proximal to any of the shelves 24. In doing so, the ladder 16 includes two or more legs 32, a set of moveable support mechanisms 34, for example, including hinges, brackets, supports, linkages, and so on, for opening and closing the ladder 16 against the base portion 14 of the cart 10, and at least one step member 36 and a top step platform 38 extending between and rotatably coupled to the legs 32. When the ladder 14 is in an open position as shown in FIGS. 12-17, the legs 32 are widened to separate from the base 14 by a distance, and in a closed position, the legs 32 are closer to the base 14 than when in the open position. For example, a support mechanism 34 may include a hinge between two rigid tubular or other elongated elements. One element may be coupled to a ladder leg 32 and the other element may be coupled to the cart frame 22. The hinge permits an acute angle to be formed between the two elements, resulting in the ladder leg 32, and the step members coupled thereto, to move in a direction of the base 14, and for the step members 36 and top step platform 38 to fold, for example, in a vertical or near vertical position, until the legs 32 are substantially parallel to the frame legs 19, for example, shown in FIG. 2. However, in some cases, the ladder step members 36 may not completely fold, and may extend at an angle tangential to the legs 32, for example, shown in FIG. 1. In some embodiments, the top step platform 38 has a surface area of other geometry that is greater than that of the other step members 36. In other embodiments, the top step platform 38 has a same or similar geometry as the other step members 36.

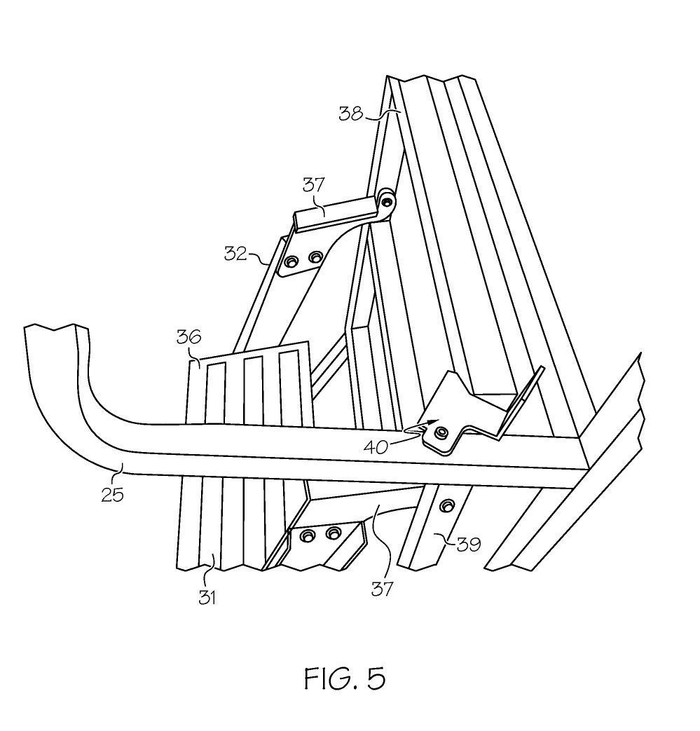

The ladder 16 may further include a support element 37 at a top of each leg 32 for receiving a bottom surface of the top step platform 38. The top step platform 38 is positioned over a top region of the legs 32 relative to the legs 32. The support element 37, for example, may be coupled by bolts or other coupling mechanism to both the leg 32 and the top step platform 38, as shown in FIG. 5, so that the support element 37 may function as a hinge as well as a protective device and/or support device with respect to preventing direct contact between the legs 32 and the step platform 38. For example, the support element 37 may move up and down with the legs 32 during a transition between an open state and a close state of the ladder 16. The support element 37 may be formed of metal, plastic or other material for providing a protective interface between the leg 32 and the step platform 38, which may otherwise experience excessive abrasion or wear and tear due to the metal components of these elements when the ladder 16 is in an open state. The support element 37 may also provide stability and support for the top step platform 38, for example, by including a base positioned under the top step 38 and supporting the weight of a user. The support element 37 may have a distinctive color, for example, yellow, that distinguishes the support element 37 from neighboring leg 32 and step platform 38 to warn a user of a possible “pinch point” where a user's hand or other body part is prone to injury during a transition between an open and closed state of the ladder 16.

In some embodiments, when in a closed position, a top of the top step platform 38 is aligned with the cart handle 25, for example, shown in FIG. 5. This permits a safety clip 40, also referred to as a top latch, to be provided, as described herein. To transition between a closed position and an open position, a side of the top step platform 38 may abut a stabilizing bar 27 or the like coupled to and extending between two front ladder legs 19.

The legs 32, support mechanism 34, step members 36, and/or top step platform 38 are coupled to each other by bolts, screws, adhesives, and/or other well-known coupling mechanisms. The legs 32, support mechanism 34, step members 36, and top step platform 38 can be formed of aluminum, sheet metal, plastic, wood, and/or related rigid materials, or a combination thereof.

In some embodiments, the steps 36 and or top step platform 38 includes one or more grip elements 31, for example, anti-slip adhesive strips, which may prevent a user on the ladder from slipping.

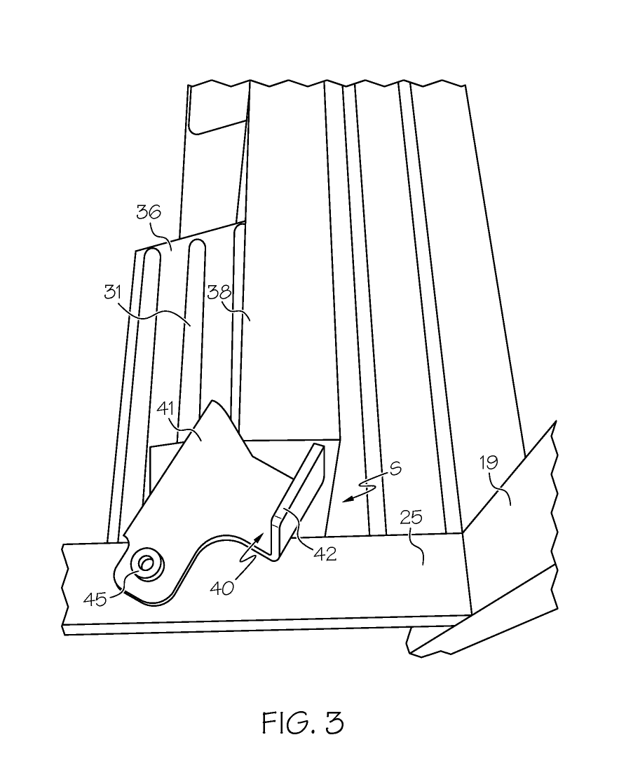

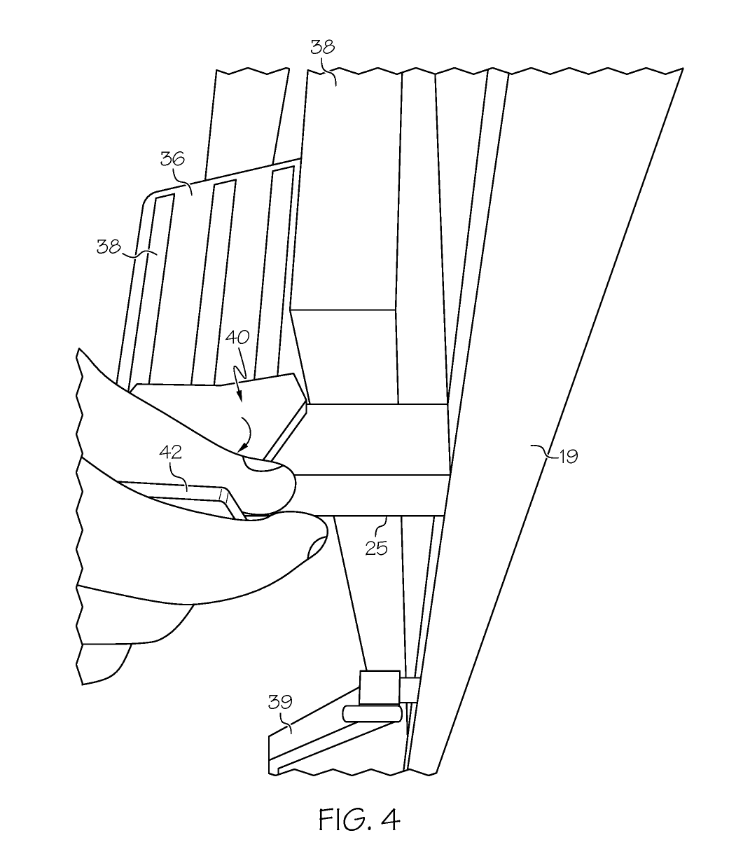

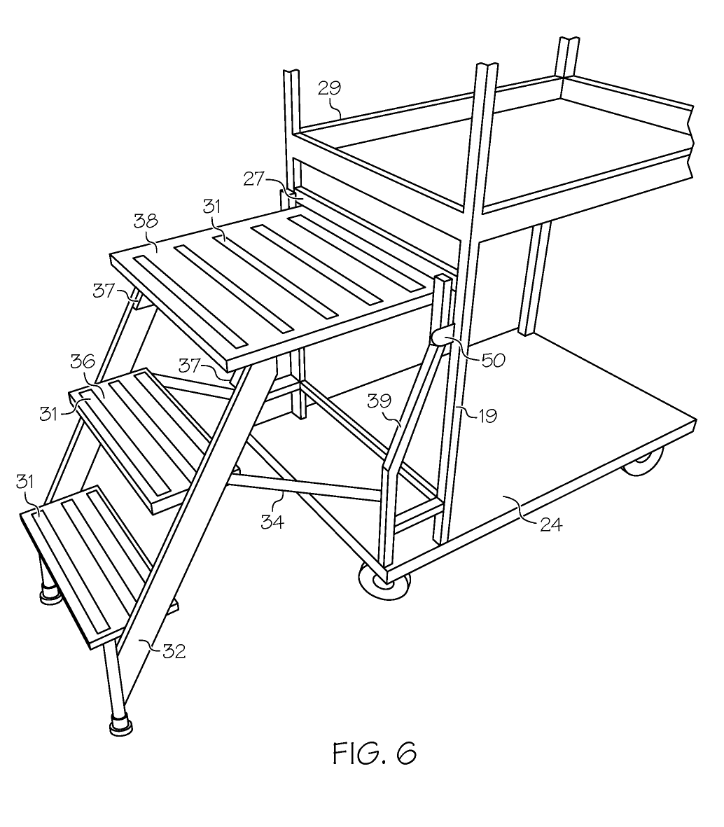

As shown in FIGS. 3-6, one or more safety clips 40 can be coupled to the ladder 16. A safety clip 40 is constructed and arranged to prevent or otherwise reduce the risk of “pinching”, or when a user's hand is injured when the hand is positioned in a space (S) between an edge of a step member 36 or top step platform 38 and the handle 25 of the cart of the wheeled base portion 14. More specifically, the space (S) may be between an edge of the top step platform 38 and a region of the handle 25, or bar 27, extending between two front frame legs 19. The safety clip 40 provides for a two handed operation, where one hand is on the safety clip 40 and the other hand is on another part of the ladder 16, for example, to open or close the ladder 16.

The safety clip 40 includes a base portion 41 and a grip portion 42 that extends from the base portion 41, for example, perpendicular or tangential to the base portion 41. The safety clip 40 may be formed of plastic or other rigid material. The safety clip 40 can rotate about a bolt 45 or other coupling mechanism that holds the safety clip 40 against the cart handle 25, or frame. As shown in FIGS. 3-6, the safety clip 40 can pivot or swivel about the axis of the coupling mechanism 45 to engage or disengage the step member 36 and/or top step platform 38 with respect to the cart base portion 14, for example, when raising or lowering the ladder 16 relative to the stationary base portion 14. This may be achieved by a user's thumb and forefinger of a first hand gripping the grip portion 42 and applying a force to rotate the clip 40 about the coupling's axis. The user's other hand can be used to move the ladder 16 accordingly.

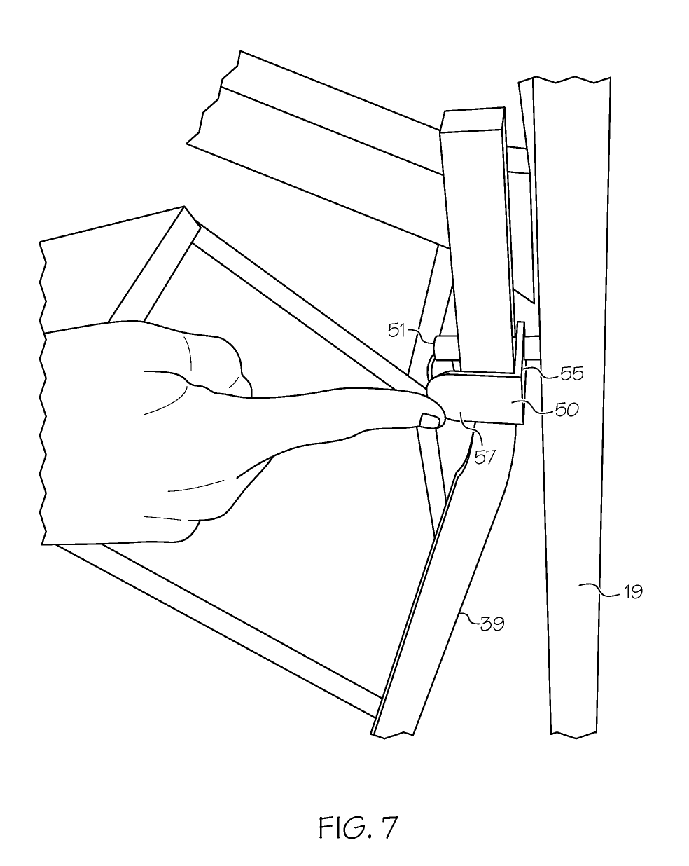

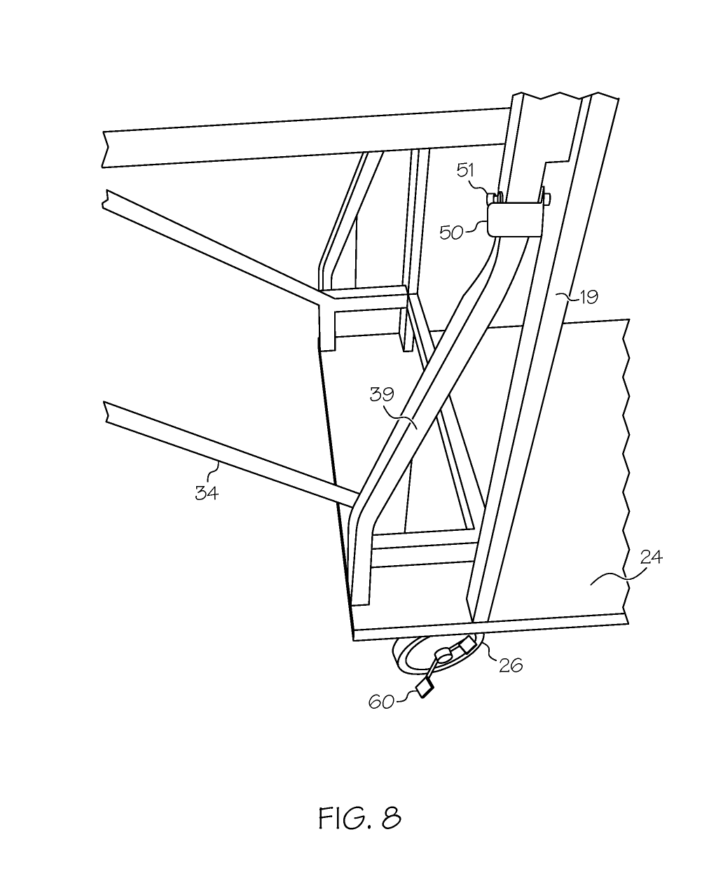

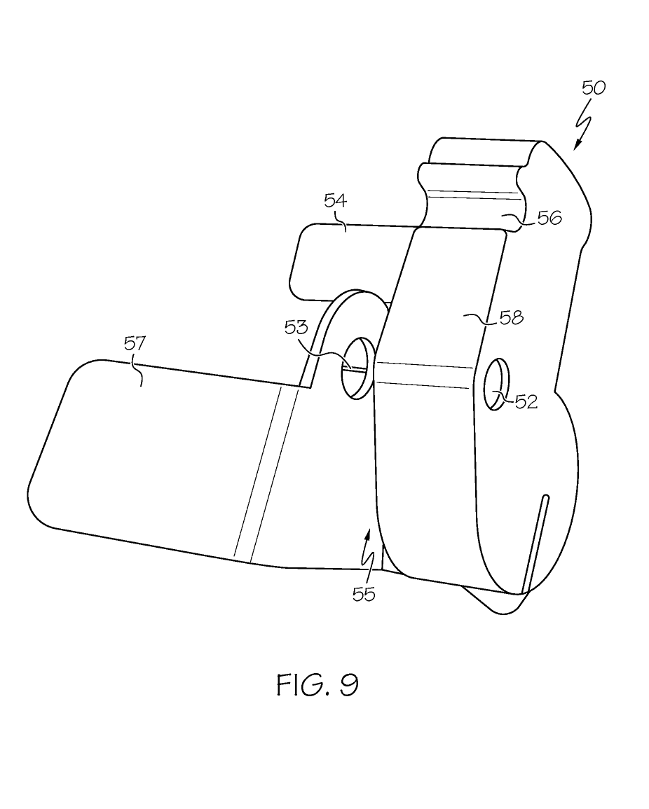

As shown in FIGS. 7-9, a latch release mechanism 50, also referred to as a lower ladder latch or bottom latch, may be coupled to a spring-based pin 51 or the like that extends from the frame 22, for example, a frame leg 19, and extends through a hole in a frame support leg 39 and through holes 52, 53 in the latch release mechanism 50, in order to position the mechanism 50 between the ladder 16 and frame 22, and release the ladder 16 with respect to the cart frame 14 so that the ladder 16 can transition between a closed position and an open position. For example, the latch release mechanism 50 can release the ladder 16 from a locked position. A body surface 58 of the latch release mechanism 50 is positioned against the frame leg 19, and may include an indentation 56, groove, or the like that mates with a protrusion (not shown) or other contour of the frame 22. Therefore, when a force is applied against the tab 57 when a user presses the tab 57, an extension 54 of the latch release mechanism 50 is separated from the frame support leg 39 adjacent the frame leg 19, allowing a cross-bar or other element of the ladder 16 to pivot about a bolt or other coupling mechanism extending through both the frame support leg 39 and ladder 16. The user can use the other hand to lift the top step 38 of the ladder while pressing the tab 57 with the other hand until the top step 38 rotates upward about an axis extending between two pivot points of the ladder legs 32, for example, 30-45 degrees from the horizontal position. Subsequently, in an operation including raising the ladder, the ladder can be lifted upward past the top latch 40 until the top step rests against a stop bar of the frame 19. The top latch 40 may spring back into position, locking the ladder 16 in a stowed position by abutting the top step 38 proximal the stop bar, for example, shown in FIG. 3.

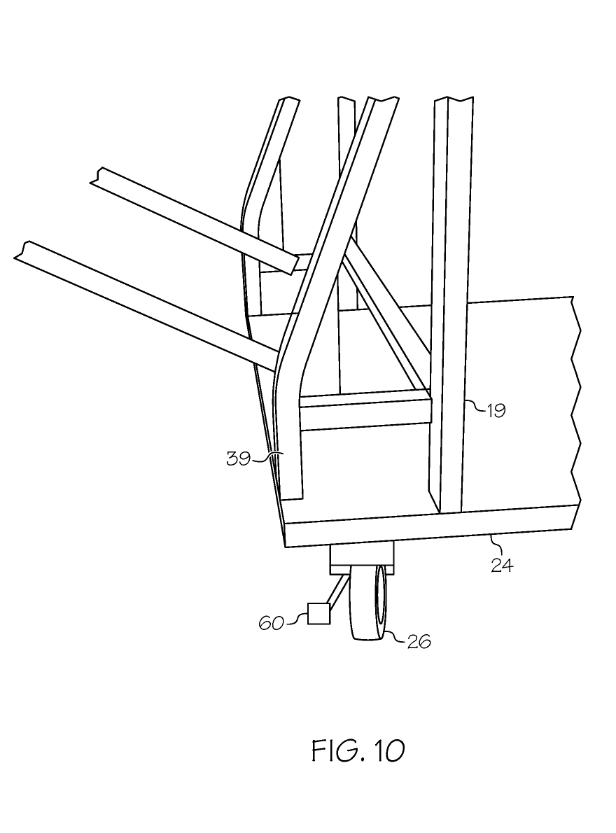

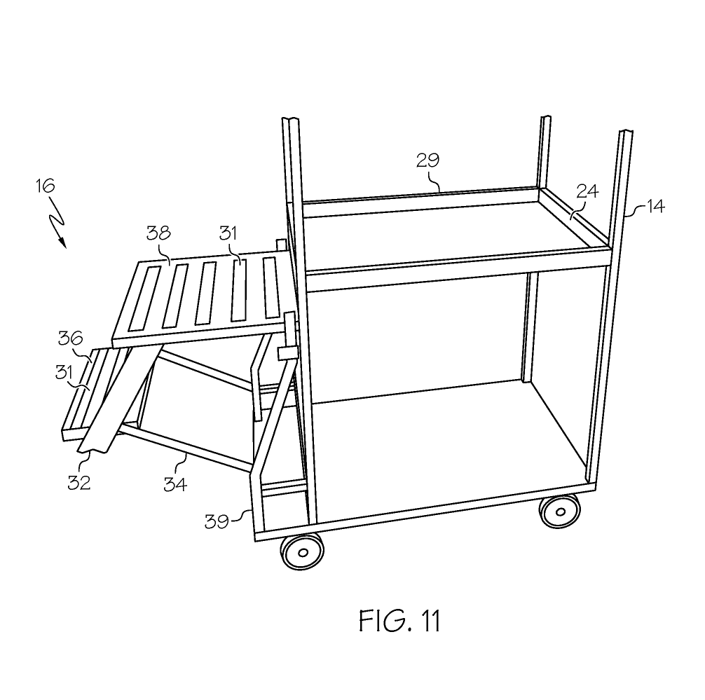

As shown in FIG. 10, the wheels 26 of the cart 10 may include a caster lock mechanism 60, for providing additional safety. This safety caster lock mechanism 60 includes an internal brake that prevents at least one wheel 26 from rolling freely, thereby preventing unwanted or unexpected movement of the cart 10 when a user is standing on the steps 36, 38 of the ladder 16 coupled to the base portion 14.

Referring FIG. 12, a corner brace 61 may be coupled about the frame 19 of the cart base 14.

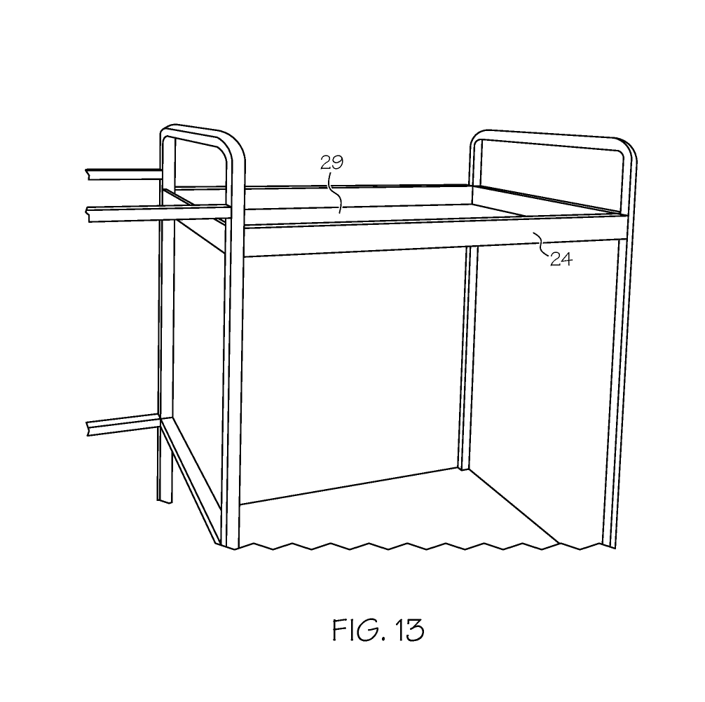

As shown in FIG. 13, a top shelf 24 of the wheeled base portion 14 of the cart 10 may include a lip 29, protrusion, or the like that extends in a substantially perpendicular direction from a planar surface of the shelf 24. In preferred embodiments, the lip 29 is part of the top shelf 24. The lip 29 may be at least one inch high, but not limited thereto. The lip 29 may be at all four sides of the shelf 24, or perimeter of the shelf 24. Alternatively, a lip 29 may be at one, two, or three sides of the shelf 24, or at a portion thereof. The lip 29 may improve a user's experience with respect to stocking functions, for example, preventing items from sliding or falling off the shelf 24. In some embodiments, the lip 29 permits partial case stocking, which allows for an improvement in perpetual inventory corrections and elimination of modular degradation of areas where consumers purchase products.

More specifically, stores typically stock shelves using a full case stocking model where all the units in a case, for example, a case of cola or beer, which must fit on the shelf 24 when stocking. If a full case cannot fit, then the entire case must be stored in the stockroom. Due to supply chain limitations (forecasting, delivery latency, etc,) not being able to support a “truck to shelf” perfection of delivery times, a partial case stocking model may be employed. In this model, if only one can of cola or beer from a case, box, or the like may fit on the shelf, then the stocking person may stock the one can and put the remainder of loose cans from that case on the topstock store shelf (distinguished from the top shelf 24 of the cart 10), for example, a shelf above a four foot section on the sales floor in ambient areas of the store.

The shelf lip 29 allows for loose items from the remainder of cases to be efficiently handled without likely possibility of loose units falling from the top shelf 24. The lip 29 also allows efficiency (due to purposeful dimensions of cart shelf) to be able to put the cart 10 in a predetermined store section, e.g., a four foot section of the store and work items down from the topstock store shelf to the shelf 24 of the cart 10, referred to as downstocking. The lip 29 permits a user to park the cart 10 in one area, batch the work in that section, without the need to move the cart 10.

Another feature of the cart 10 allows a retail store to use the cart 10 when performing an automated business process using a device referred to as an “automated section work” which includes a mobile electronic device such as a personal assistant, smartphone, and so on, which allows a stocking person to make error free adjustments to item count (increment and decrement) to increase accuracy of perpetual inventory.

The foregoing and other features and advantages of the invention will be apparent to those of ordinary skill in the art from the following more particular description of the invention and the accompanying drawings.

A number of implementations have been described. Nevertheless, it will be understood that the foregoing description is intended to illustrate and not to limit the scope of the inventive concepts which are defined by the scope of the claims. Other examples are within the scope of the following claims.

What is claimed is:

1. A cart for transporting items, comprising:
a base portion, comprising:
a frame;
at least one shelf coupled to the frame; and
a set of wheels at the bottom of the frame permitting a movement of the cart; and
a collapsible ladder directly attached to the frame.

2. The cart of claim 1, wherein the ladder comprises:
first and second legs;
at least one step member between the first and second legs;
a top step platform above a top region of and between the first and second legs; and
a set of support mechanisms for arranging the ladder in an open or close position relative to the base portion.

3. The cart of claim 2, wherein the base portion further comprises a handle, and wherein the top step platform is aligned with the handle along a common axis.

4. The cart of claim 3, further comprising a safety clip between an edge of the top step platform of the ladder and the handle of the base portion cart of the base portion.

5. The cart of claim 2, wherein the ladder further comprises a support element between each of the first and second legs and the top step platform.

6. The cart of claim 1, further comprising a latch release mechanism for maintaining the ladder in one of the open or close position, and for permitting a transition between the open and close position.

7. The cart of claim 1, wherein the base portion further comprises a caster lock mechanism.

8. The cart of claim 1, wherein a top shelf of the at least one shelf of the base portion comprises a lip about at least a portion of a perimeter of the top shelf.

9. The cart of claim 1, wherein the at least one shelf includes a top shelf having a lip about a perimeter of the top shelf for partial case stocking.

10. The cart of claim 1 wherein the base portion is constructed and arranged to items for transport from an automated product sorting and/or unload machine.

11. A cart for retrieving items from a top shelf of a store or warehouse, comprising:
a base portion, comprising:
a frame;
a plurality of shelves coupled to the frame, the shelves including a top shelf having a lip about a perimeter of the top shelf; and
a set of wheels at the bottom of the frame permitting a movement of the cart; and
a collapsible ladder directly attached to the frame, the ladder comprising a plurality of steps including a top step platform that supports the weight of a user and allows the user to transport items to and from the top shelf of the store or warehouse or the top shelf of the base portion of the cart.

12. The cart of claim 11, wherein the ladder comprises:
first and second legs;
the top step platform above a top region of and between the first and second legs; and
a set of support mechanisms for arranging the ladder in an open or close position relative to the base portion.

13. The cart of claim 11, further comprising a safety clip between an edge of the top step platform of the ladder and the base portion.

14. The cart of claim 11, further comprising a latch release mechanism for maintaining the ladder in one of the open or close position, and for permitting a transition between the open and close position.

15. The cart of claim 11, wherein the base portion further comprises a caster lock mechanism.

16. The cart of claim 11, wherein a top shelf of the at least one shelf of the base portion comprises a lip about at least a portion of a perimeter of the top shelf.

17. A cart for transporting items, comprising:
a base portion, comprising:
a frame; and
a plurality of shelves coupled to the frame;
a collapsible ladder directly attached to the base portion;
a top latch that transitions the ladder between a closed position and an open position to engage or disengage a top step platform of the ladder when raising or lowering the ladder with respect to the base portion; and
a bottom latch that disengages the ladder from the frame to allow the ladder to move in a direction of the top latch when a force is applied to the bottom latch.

18. The cart of claim 17, wherein the bottom latch comprises:
a body surface positioned against a frame leg of the frame;
an extension positioned behind a frame support leg of the frame for supporting the ladder in the open position.

19. The cart of claim 17, wherein the top latch includes a safety clip constructed and arranged to prevent a user's hand from insertion into a space between the top step platform of the ladder and the base portion
